(19) United States
(12) Patent Application Publication
(10) Pub. No.: US 2015/0193549 A1
(43) Pub. Date: Jul. 9, 2015

(54) HISTORY AS A BRANCHING VISUALIZATION

(71) Applicant: Microsoft Corporation, Redmond, WA (US)

(72) Inventors: Robert Frye, Seattle, WA (US); Kelly E. Rollin, Seattle, WA (US); Lan Ye, Seattle, WA (US)

(73) Assignee: Microsoft Corporation, Redmond, WA (US)

(21) Appl. No.: 14/150,237

(22) Filed: Jan. 8, 2014

(51) Int. Cl. G06F 17/30; G06F 3/0482

(52) U.S. Cl. CPC G06F 17/30876; G06F 3/0482

(57) ABSTRACT

Architecture that enables the visualization of history data of a prior content (or document) navigation session in a user interface (UI), the session presented as a structure of nodes and branches between the nodes that represent the paths navigated by the user during the session. The user can then choose to go back to a previous state of the session via the structure, and then take another route. This capability enables the user to more effectively revisit a decision-making process at least with respect to retracing navigation over numerous documents. The history data of a prior navigation session is presented to the user as a graphical view structured as a branching visualization of the nodes and node branches. The user can interact with the graphical view to move forward and backward in the time span of the session and retrieve the document as any given point in the previous session.

### BACKGROUND

While browsing an application, website, file system, hierarchical document, etc., users will frequently make use of user interface controls (e.g., a Back button) to move to a previous state, click a few more times to establish new states, and then move to a previous state again, and so on. Flat lists of browse history are common, but do not account for the back and forth behavior. When browsing either in websites or applications (e.g., during within an e-commerce website or application), users are frequently presented with many branches in the navigation path (e.g., related items, suggested items, other categories, etc.). The result is that users frequently lose track of all the content viewed within a given amount of time. This leads to user fatigue, as well as the annoyance of getting lost and not being able to navigate back to what they were looking in the beginning or a much removed prior state.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables the visualization of history data of a prior content (or document) navigation session in a user interface (UI), the session presented as a structure of nodes and branches between the nodes that represent the paths navigated by the user during the session. The user can then choose to go back to a previous state of the session via the structure, and then take another route. This capability enables the user to more effectively revisit a decision-making process at least with respect to retracing navigation over numerous documents.

The history data of a prior navigation session is presented to the user as a graphical view structured as a branching visualization of the nodes and node branches. The user can interact with the graphical view to move forward and backward in the time span of the session and retrieve the document as any given point in the previous session. Moreover, the branching visualization serves as a map that traces the user navigation over documents and content during the session.

In one implementation, the architecture provides a UI control (e.g., a slider) that enables the user to retrieve and visualize previous browsing behavior over time, whether browsing web documents or application documents (e.g., local applications), as well as showing a preview of the content at each step (node), and the capability to jump back to any step (node) of the session. The visualization of the content of a particular node may be presented adjacent to the branch and/or directly in the node, if space allows, for example.

The system can include a history component configured to collect history data associated with content and data references (e.g., hyperlinks) that point to the content of a content navigation session. The history data can be of a hierarchical structure associated with the content navigation session. A visualization component can be provided and configured to generate a graphical view of the history data (as a branching visualization) as nodes, and branches between the nodes that correlate to the structure (e.g., hierarchical). The nodes represent the content, and the branches between the nodes represent the data references that relate (link) nodes or facilitate navigation from one piece of content to another piece of content.

For example, when applied to web browser applications, after presenting a webpage having different pieces and types of content (e.g., image, text, audio, video, etc.), the webpage has an associated data reference, which can be the path information to that webpage. Within the webpage, an image, if selected, can cause the browser to navigate to a new web document associated with the image, as facilitated by the data reference for that new web document assigned to the image.

The branching visualization could be implemented vertically, horizontally (as shown herein), or in three or more dimension space. Alternative to navigation through the branching structure by way of dragging a slider control with a mouse, or by clicking directly on the nodes or branches, in a touch environment, tapping on a node or dragging the slider control with a finger or pointing device can also be enabled.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an exemplary graphical view of a branching visualization generated for interactive presentation of the history data.

FIG. 3 illustrates a user interface that facilitates access by the user to a specific content navigation session or point in the session.

FIG. 4 illustrates a user interface of a branching visualization of history data, starting with a first item and user interaction over a single node.

FIG. 5 illustrates the user interface of the branching visualization of history data and user interaction over two nodes.

FIG. 6 illustrates the user interface of the branching visualization of history data that facilitates content selection of another document.

FIG. 7 illustrates a method in accordance with the disclosed architecture.

FIG. 8 illustrates an alternative method in accordance with the disclosed architecture.

FIG. 9 illustrates illustrated a block diagram of a computing system 900 that executes history data as a branching visualization in accordance with the disclosed architecture.

### DETAILED DESCRIPTION

Traditionally users have been constrained to using a Back user interface (UI) control to move backward sequentially and incrementally through previous steps; however, this does not account for branches taken by the user during the session, and also requires users to move through history sequentially. History lists in web browsers may offer similar functionality, but do not visualize where branches occurred, and do not typically enable the user to preview the content.

The disclosed architecture generates and presents the history data for a previous document navigation session as a set of nodes and branches between the nodes so that the user can visualize browsing behavior over time. This enables the capture and viewing of Back button usage, as well as showing a preview of the content at each step (node), and the ability to jump back to any step (node) of the session.

The architecture generates and presents a data rich, graphical representation of the user's browsing history, which enables the user to revisit a browsing session not only sequentially, but also to access a previously visited document directly, through non-sequential browsing.

The architecture also provided the capability to filter the browsing history by domain or other themes such as “shopping”. In other words, it can be the case that during a single browsing session, the user navigates away from a central context of news hopping to shopping. Although the branching visualization generated from the history data will include these two contexts of news and shopping, the visualization can be filtered to only present the structure for news or only the structure for shopping, thereby filtering out unwanted content at the given time. Thus, when retracing through the structure for content at the nodes, the user is not wasting time hopping over content unrelated to the desired context. The branching visualization could be implemented vertically, horizontally (as shown herein), or in three or more dimension space.

Alternative to navigation through the branching structure by way of dragging a slider control with a mouse, or by clicking directly on the nodes or branches, in a touch environment, tapping on a node or dragging the slider control with a finger or pointing device can also be enabled.

User interaction with the graphical view can be gesture-enabled, whereby the user employs one or more gestures for interaction. For example, the gestures can be natural user interface (NUI) gestures. NUI may be defined as any interface technology that enables a user to interact with a device in a “natural” manner, free from artificial constraints imposed by input devices such as mice, keyboards, remote controls, and the like.

Examples of NUI methods include those methods that employ gestures, broadly defined herein to include, but not limited to, tactile and non-tactile interfaces such as speech recognition, touch recognition, facial recognition, stylus recognition, air gestures (e.g., hand poses and movements and other body/appendage motions/poses), head and eye tracking, voice and speech utterances, and machine learning related at least to vision, speech, voice, pose, and touch data, for example.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems, all of which provide a more natural user interface, as well as technologies for sensing brain activity using electric field sensing electrodes (e.g., electro-encephalograph (EEG)) and other neuro-biofeedback methods.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

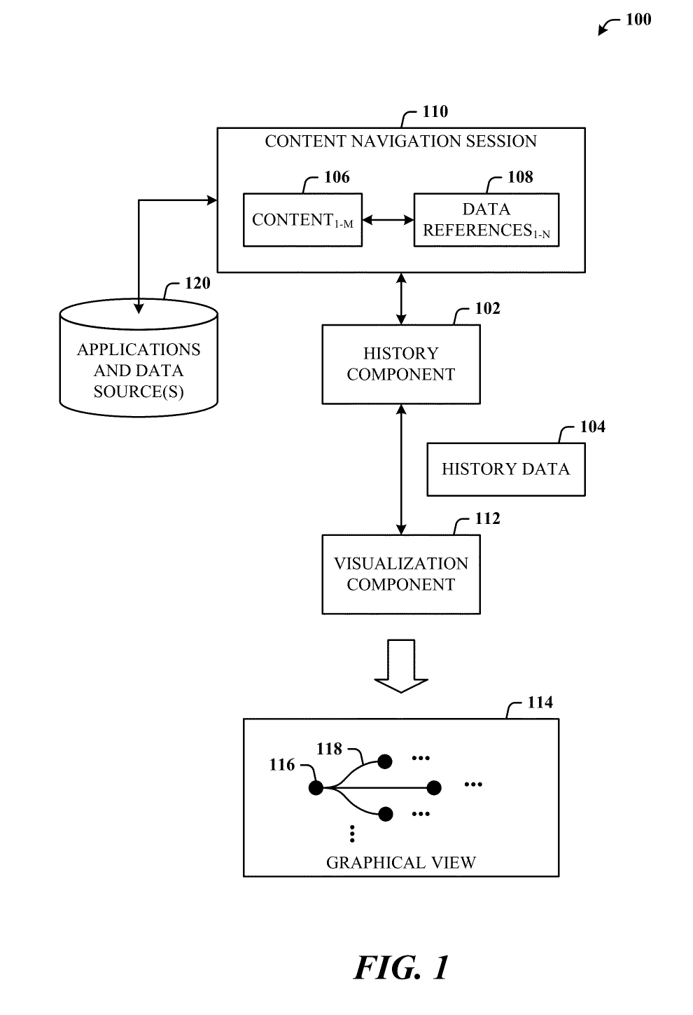

FIG. 1 illustrates a system 100 in accordance with the disclosed architecture. The system 100 can include a history component 102 configured to collect history data 104 associated with content 106 and data references 108 (e.g., hyperlinks) that point to the content 106 of a content navigation session 110. The history data 104 can be of a hierarchical structure associated with the content navigation session 110.

A visualization component 112 can be provided and configured to generate a graphical view 114 of the history data 104 (as a branching visualization) as nodes 116, and branches 118 between the nodes 116 that correlate to the hierarchical structure. The nodes 116 represent the content 106, and the branches 118 between the nodes represent the data references 108 that link nodes or facilitate navigation from one piece of content to another piece of content. For example, when applied to web browser applications, after presenting a webpage having different pieces and types of content (e.g., image, text, audio, video, etc.), the webpage has an associated data reference, which can be the path information to that webpage. Within the webpage, an image, if selected, can cause the browser to navigate to a new web document associated with the image, as facilitated by the data reference for that new web document assigned to the image.

The implementation of the branching visualization of history data, as in the graphical view 114, is applicable at least in the context of applications and data sources 120, which include, but are not limited to, content-driven applications (e.g., a shopping application), a web browser, a website, a file browser or file structure, a multi-page document (e.g., presentation applications such as PowerPoint™, word-processing documents, portable document format (PDF) applications, etc.), a wizard interface, and/or any other program or document that enables users to select or navigate through a hierarchical structure, including an option to navigate back, or where users may navigate through a linear structure in a non-linear manner (e.g., as in PowerPoint).

It is to be understood that in the disclosed architecture, certain components may be rearranged, combined, omitted, and additional components may be included. Additionally, in some embodiments, all or some of the components are present on the client, while in other embodiments some components may reside on a server or are provided by a local or remove service.

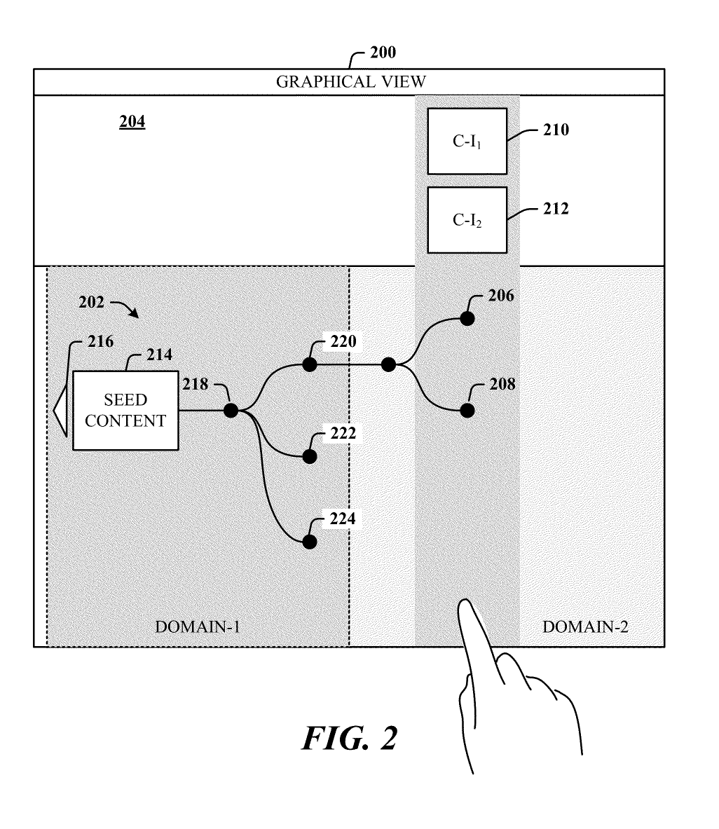

FIG. 2 illustrates an exemplary graphical view 200 of a branching visualization 202 generated for interactive presentation of the history data 104. In this implementation, the graphical view 200 is further annotated by domains such as a Domain-1 and a Domain-2. When used for shopping, for example, the domains can be a first clothing store (Domain-1) and a second clothing store (Domain-2), since the content navigation session will likely include one or more clothing websites and webpages of the sites that depicts the apparel in which the user may have been interested at that time.

In this example, the graphical view 200 can comprise an image (or content) section 204 (for snapshot or thumbnail images or other types of media) in which content images can be presented based on user interaction with a node and/or node branch. For example, here, a user touches (interacts with) an area of a device touch display associated with or relative to two nodes of the second domain: a first node 206 and a second node 208. In response, the system retrieves and presents images from the history data associated with the two nodes (206 and 208): a first content image (C-I₁) 210 and a second content image (C-I₂) 212. Thus, the user can instantly see in the branch history (of the history data) where the content and associated document sources exist, and additionally, relative in time and order to other content sources for the given content navigation session (e.g., a web browsing session).

As described herein, the user can then select (e.g., touch) one of the images, for example, the second image 212, in response to which the system will route the user view to the associated content source, such as a web page, or other type of related document, where the user can then choose to continue a new session or return to the branching visualization 202.

Note that the branching visualization 202 can begin with a seed content 214 that provides an indication to the user as to the context of the overall content navigation session, such as shoes, coat, travel, gold, etc. It can also serve as the starting point from which to continue a segment of the overall content navigation session. In other words, a content navigation session can be extensive, over many documents and pieces of content, yet the user need not be burdened with being presented and interacting with the entire branching history of a session; although, this can be accommodated using the disclosed architecture.

In one implementation, it can be the case that a back control 216 is provided proximate the seed content 214 to enable the user to move backward in time in the historical session relative to the seed content 214. In this instance, the user is then allowed to scroll earlier in time in the selected overall content navigation session than that which is presented. This capability enables the presentation of the branching visualization 202 for different computing devices having varying display sizes, such as handheld devices, smartphones, tablets and portable computers.

In this example, the content navigation session (which can be the entire session or part of a session) is visually represented in the graphical view 200 as comprising seven nodes and seven branches. Four of the nodes are associated with the first domain (Domain-1) and the remaining three nodes are associated with the second domain (Domain-2). The user can be presented with this graphical view 200 based on the selection of one of many prior sessions related to the first domain, as provided in a listing. For example, the listing can include prior sessions by date and a short description about the session or session content.

The branch history of the first domain indicates the user navigated from the first node 218 to a second node 220, back from the second node 220 to the first node 218 and then to a third node 222, back from the third node 222 to the first node 218 and then to a fourth node 224, and then back to the first node 218. It is to be understood that the order of navigation just described need not occur in the described order, in that, for example, the user may have navigated first from the first node 218 to the fourth node 224, back from the fourth node 224 to the first node 218 and then to the second node 220, and then from the second node 220 to the second domain branch history.

It is within contemplation of the disclosed architecture that the branches may also be annotated with interactive text, images, audio clips, video clips, etc., such that the user can readily see an indication of content associated with that branch. Accordingly, the user may not need to interact directly with the nodes as shown to surface the images (210 and 212). This, and other features/capabilities, can be made user configurable.

Put another way, the graphical view 200 (and, for example, the graphical view 114 of FIG. 1, and any other views described herein) can comprise one or more content images (210 and/or 212) presented in response to interaction with a corresponding node or nodes (206 and/or 208). The graphical view 200 of the history data is presented based on interaction with content associated with the history data.

The interaction (e.g., using one or more NUI gestures) with the content (e.g., first image 210) automatically navigates to a webpage (or other related or referenced document type) associated with content. The visualization component can graphically differentiate the nodes (e.g., nodes 206, 208, 218, 220, 222, and 224) of the graphical view 200 by domain (e.g., Domain-1 and Domain-2), for example, or by context (e.g., shopping, news, blogs, etc.).

The graphical view 200 is presented in response to selection of a specific content topic from a list of content topics that relate to one or more content navigation sessions. The visualization component is configured to enable interactive forward and backward navigation of the branching history (visualization) in the graphical view 200 to perceive content in the content navigation session.

The branching visualization 202 can be implemented vertically, horizontally (as shown in FIG. 1 and FIG. 2), or in higher multi-dimensional space such as 3D (x, y and z axis). Additionally, navigation through the structure of the branching visualization 202 can be accomplished by way of dragging a slider control with a mouse, by clicking directly on the nodes or branches, etc. In a touch environment, tapping on a node or dragging the slider control with a finger or pointing device can also be enabled. In a gestural control environment, the user can move from node to node (or among multiple branches) via the use of an air gesture such as a hand swipe.

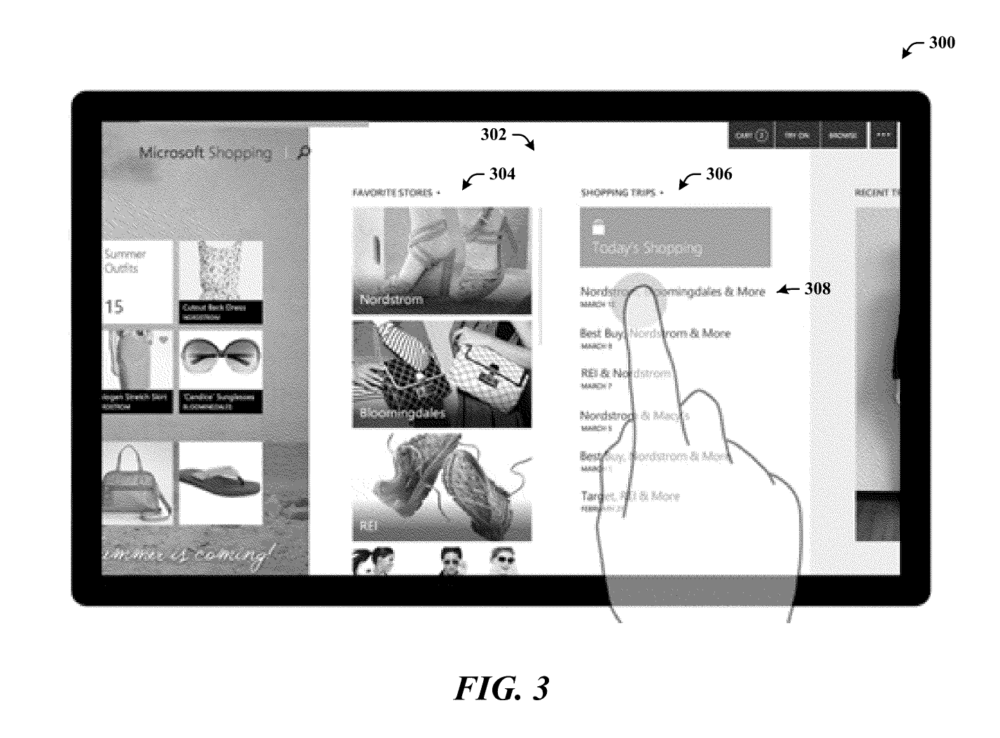

FIG. 3 illustrates a user interface 300 that facilitates access by the user to a specific content navigation session or point in the session. In one example, the user is presented with a list 302 that represents a span of time in session history (e.g., “Today”, “Yesterday”, “Current Store”, etc.) as well as domains. Here, the list 302 can show a set of interactive domains 304, as represented by domain images. The list 302 can also show particular time spans for several past sessions 306. The time spans can be for a single day and for a single or multiple domains. For example, the user can select a list item 308 described as “Domain-1, Domain-2 & More” on a specific date, which covers content viewed in a session on that date.

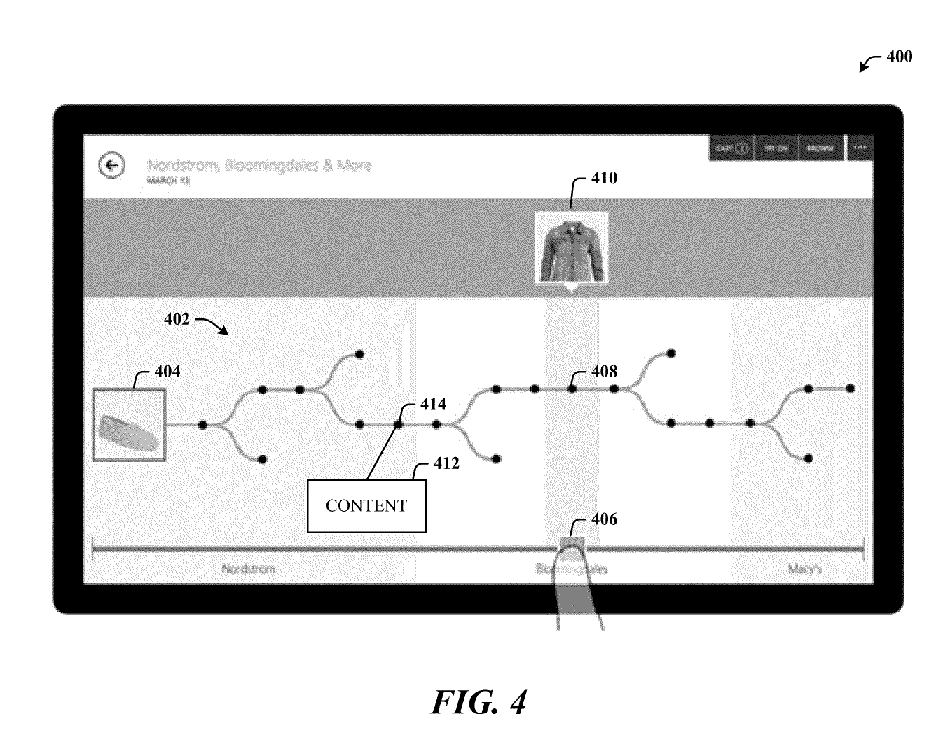

FIG. 4 illustrates a user interface 400 of a branching visualization 402 of history data, starting with a first item 404 (e.g., an ecommerce product). Based on a selection of the list item 308 in the UI 300 of FIG. 3, the branching visualization 402 is presented having three domains explored during a March 13 session. In this particular view, the UI 400 also provides slider control 406 that when selected and dragged enables the user to quickly navigate over nodes to see the associated content (snapshots) presented. Here, on a given node 408, the content 410 is presented when the slider control 406 is associated with the node 408. An alternative method to show node-related content can be via a content box 412 presented proximate the related node 414 of the branching visualization 402.

The content box 412 can be activated for presentation by hovering an input device pointer over the node 414, finger tapping, voice command execution, etc. Additionally, in lieu of or in combination with the slider control 406, the user can cause a pointer (or cursor) to automatically move over and follow the trace of the branching visualization 402 to show content at each node intersected along the trace. This also can include the playing of media and/or presenting media metadata (e.g., title, author, artist, date, etc.) associated with each node as the node content.

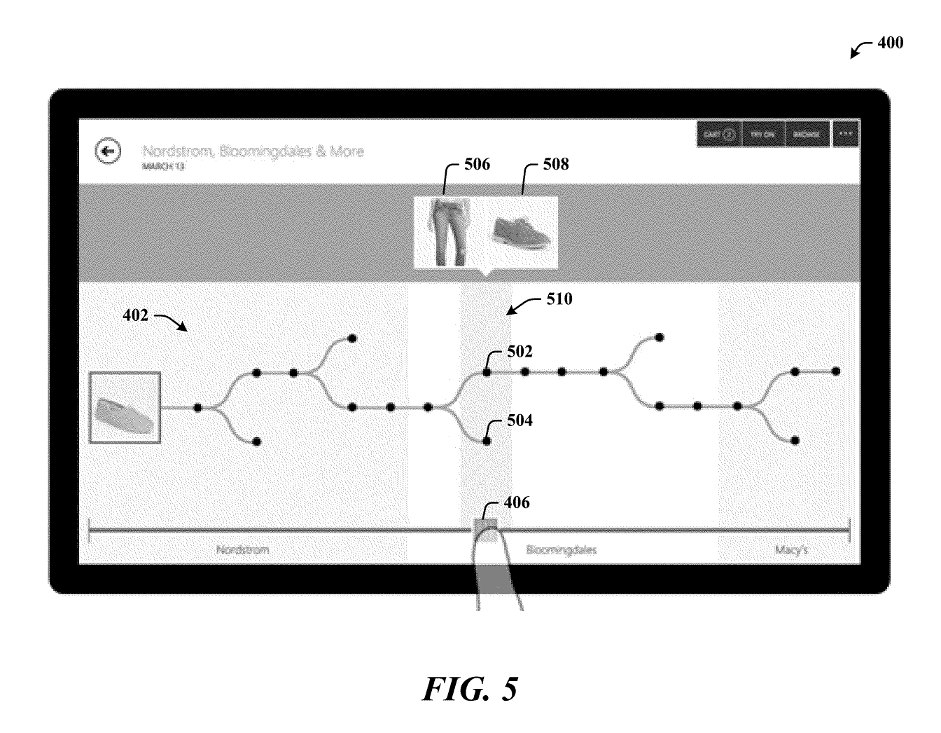

FIG. 5 illustrates the user interface 400 of the branching visualization 402 of history data. In this particular view, the user has moved the slider control 406 in association with nodes (502 and 504) to see the associated content snapshots presented. Here, content thumbnail images (506 and 508) are presented when the slider control 406 associated with the nodes (502 and 504). The associative aspect between the slider control 406 and the nodes (502 and 504) is visually depicted as a grayed vertical bar 510 for ready user perception as being associated. The user can drag the slider control 406 backward (left) and forward (right) in time to see a snapshot of content previously viewed in the session. The paths used by the user to navigate to a new destination (node), then back, and navigated to a different destination, are represented as the branches.

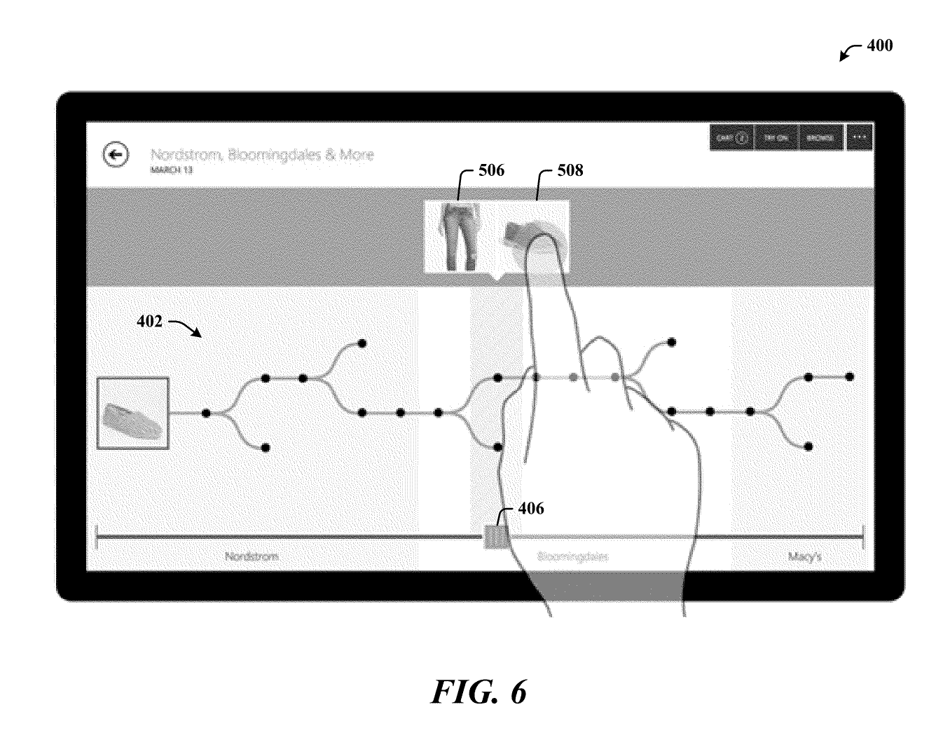

FIG. 6 illustrates the user interface 400 of the branching visualization 402 of history data. In this particular view, the user has moved the slider control 406 in association with nodes (502 and 504) to see the associated content thumbnail images (506 and 508). The user then chooses to select the content thumbnail 508 to navigate to the associated document (e.g., a webpage).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

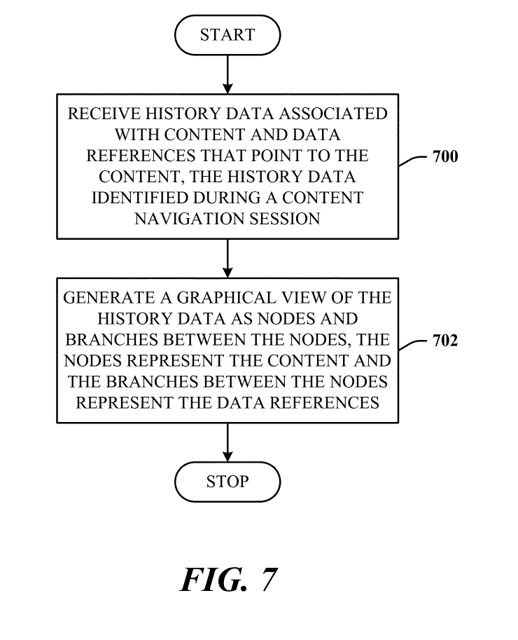

FIG. 7 illustrates a method in accordance with the disclosed architecture. At 700, history data associated with content and data references that point to the content are received. The history data is identified during a content navigation session such as a web session or a local application navigation session, for example. At 702, a graphical view (branching visualization) of the history data is generated as nodes and branches between the nodes. The nodes represent the content and the branches between the nodes represent the data references.

The method can further comprise presenting content at a specific point of the content navigation session based on interaction with a corresponding node in the view. This can be accomplished by interaction with a node or nodes of the branching visualization. The method can further comprise annotating the graphical view of the nodes and branches by domain. This enables the user to readily ascertain the specific number of nodes associated with a particular domain, and thus, how much activity the user spent at that domain. The method can further comprise returning to a point of the content navigation session via interaction with a node or branch of the view. This can be accomplished by the user directly interacting with a prior node of the graphical view, and operates to bring the user back to an associated webpage or application document form which the content was obtained.

The method can further comprise presenting a snapshot (or thumbnail) view of content of the content navigation session based on interaction with a corresponding node or a branch. The content can also be presented as a form of audio link that when selected plays an audio clip. Alternatively, the content associated with a node can be a short video clip that is automatically played when the related node selected (e.g., hovered over).

The method can further comprise jumping back to a specific point in the history data based on selection of corresponding previous node in the graphical view. This can be performed using a slider control or direct interaction with the node or nodes. The method can further comprise presenting the graphical view of the history data as a structure of nodes and node branches that correlate to a hierarchical structure of the history data.

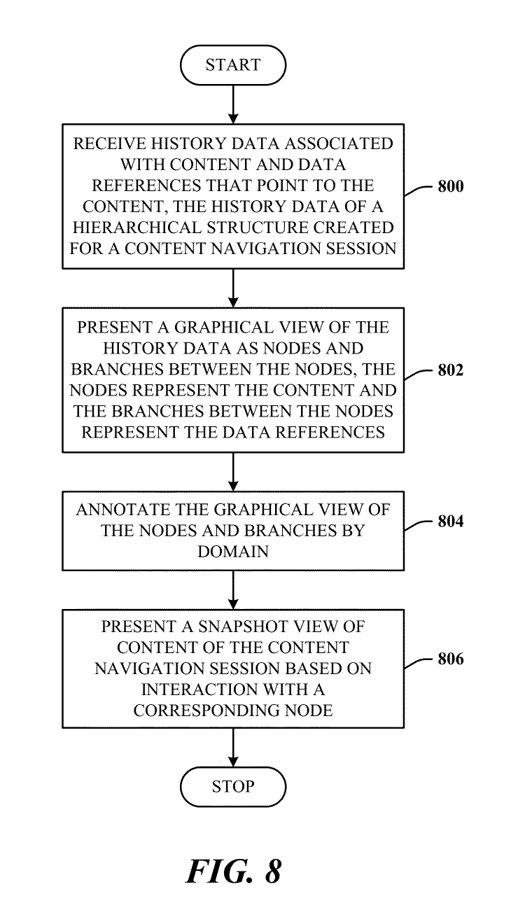

FIG. 8 illustrates an alternative method in accordance with the disclosed architecture. The method can be performed via a computer-readable storage medium comprising computer-executable instructions that when executed by a microprocessor, cause the microprocessor to perform acts of the method. At 800, history data associated with content and data references that point to the content are received. The history data is of a hierarchical structure created for a content navigation session. At 802, a graphical view of the history data is presented as nodes and branches between the nodes, the nodes represent the content and the branches between the nodes represent the data references. At 804, the graphical view of the nodes and branches is annotated by domain. At 806, a snapshot view of content of the content navigation session is presented based on interaction with a corresponding node.

The method can further comprise presenting content at a specific point of the content navigation session based on interaction with a corresponding node in the view. One implementation can show the content of nodes in small panels with line tags to the given node. The method can further comprise returning to a point of the content navigation session (e.g., a webpage) via interaction with a node or branch of the view.

The method can further comprise presenting a list of content topics that relate to one or more content navigation sessions and corresponding history data based on selection of a specific content topic. The method can further comprise graphically differentiating the nodes of the graphical view by domain. The domains and related nodes/branches can be differentiated by correspondingly distinct graphical emphasis (e.g., colored blocks). The method can further comprise navigating to a web document based on selection of content associated with a node.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

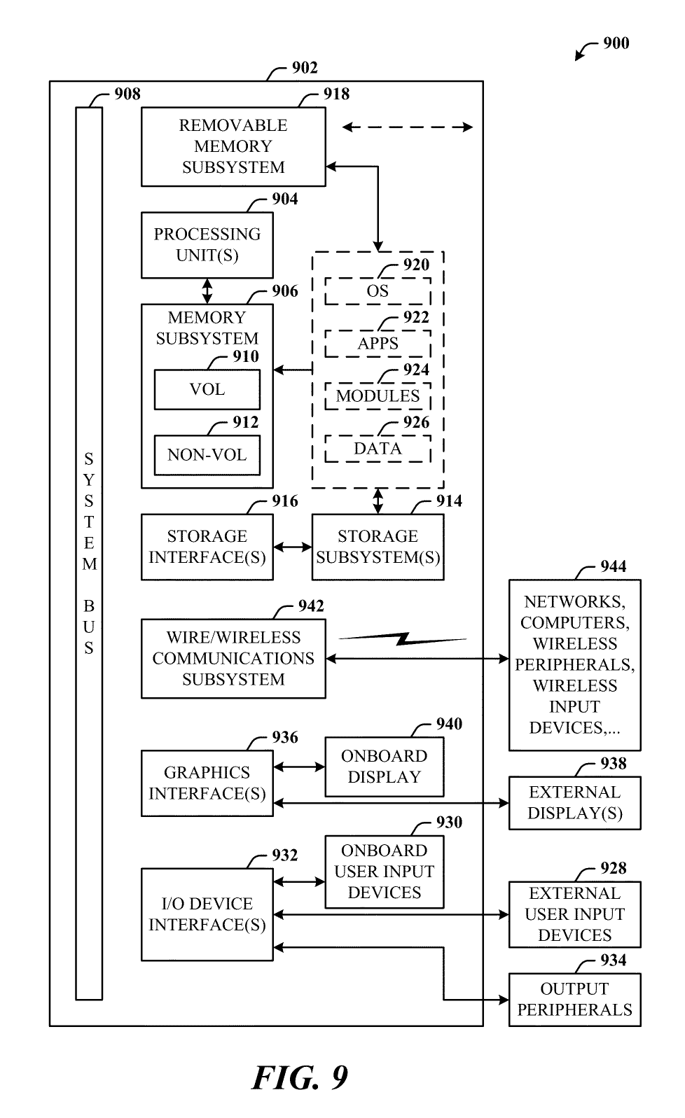

Referring now to FIG. 9, there is illustrated a block diagram of a computing system 900 that executes branching history visualization in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having microprocessing unit(s) 904 (also referred to as microprocessor(s) and processor(s)), a computer-readable storage medium such as a system memory 906 (computer readable storage medium/media also include magnetic disks, optical disks, solid state drives, external memory systems, and flash memory drives), and a system bus 908. The microprocessing unit(s) 904 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 902 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 906 can include computer-readable storage (physical storage) medium such as a volatile (VOL) memory 910 (e.g., random access memory (RAM)) and a non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the microprocessing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components and circuits. The storage subsystem(s) 914 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The operating system 920, one or more application programs 922, other program modules 924, and/or program data 926 can include items and components of the system 100 of FIG. 1, items and components of the view 200 of FIG. 2, items and components of the UI 300 of FIG. 3, items and components of the UI 400 of FIG. 4, items and components of the UI 400 of FIG. 5, items and components of the UI 400 of FIG. 6, and the methods represented by the flowcharts of FIGS. 7 and 8, for example.

Generally, programs include routines, methods, data structures, other software components, etc., that perform particular tasks, functions, or implement particular abstract data types. All or portions of the operating system 920, applications 922, modules 924, and/or data 926 can also be cached in memory such as the volatile memory 910 and/or non-volatile memory, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 902, and include volatile and non-volatile internal and/or external media that is removable and/or non-removable. For the computer 902, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 902, programs, and data using external user input devices 928 such as a keyboard and a mouse, as well as by voice commands facilitated by speech recognition. Other external user input devices 928 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 902, programs, and data using onboard user input devices 930 such a touchpad, microphone, keyboard, etc., where the computer 902 is a portable computer, for example.

These and other input devices are connected to the microprocessing unit(s) 904 through input/output (I/O) device interface(s) 932 via the system bus 908, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a history component configured to collect history data associated with content and data references that point to the content of a content navigation session, the history data a hierarchical structure associated with the content navigation session;
a visualization component configured to generate a graphical view of the history data as nodes and branches between the nodes that correlate to the hierarchical structure, the nodes represent the content and the branches between the nodes represent the data references; and
at least one microprocessor configured to execute computer-executable instructions in a memory associated with the history component and the visualization component.

2. The system of claim 1, wherein the graphical view comprises one or more content images presented in response to interaction with a corresponding node.

3. The system of claim 1, wherein the graphical view of the history data is presented based on interaction with content associated with the history data.

4. The system of claim 1, wherein the interaction with the content automatically navigates to a webpage associated with content.

5. The system of claim 1, wherein the visualization component graphically differentiates the nodes of the graphical view by domain.

6. The system of claim 1, wherein the graphical view is presented in response to selection of a specific content topic from a list of content topics that relate to one or more content navigation sessions.

7. The system of claim 1, wherein the visualization component is configured to enable interactive forward and backward navigation of the graphical view to perceive content in the content navigation session.

8. A method, comprising acts of:
receiving history data associated with content and data references that point to the content, the history data identified during a content navigation session; and
generating a graphical view of the history data as nodes and branches between the nodes, the nodes represent the content and the branches between the nodes represent the data references.

9. The method of claim 8, further comprising presenting content at a specific point of the content navigation session based on interaction with a corresponding node in the view.

10. The method of claim 8, further comprising annotating the graphical view of the nodes and branches by domain.

11. The method of claim 8, further comprising returning to a point of the content navigation session via interaction with a node or branch of the view.

12. The method of claim 8, further comprising presenting a snapshot view of content of the content navigation session based on interaction with a corresponding node or a branch.

13. The method of claim 8, further comprising jumping back to a specific point in the history data based on selection of corresponding previous node in the graphical view.

14. The method of claim 8, further comprising presenting the graphical view of the history data as a structure of nodes and node branches that correlate to a hierarchical structure of the history data.

15. A computer-readable storage medium comprising computer-executable instructions that when executed by a microprocessor, cause the microprocessor to perform acts of:
receiving history data associated with content and data references that point to the content, the history data of a hierarchical structure created for a content navigation session;
presenting a graphical view of the history data as nodes and branches between the nodes, the nodes represent the content and the branches between the nodes represent the data references;
annotating the graphical view of the nodes and branches by domain; and
presenting a snapshot view of content of the content navigation session based on interaction with a corresponding node.

16. The computer-readable storage medium of claim 15, further comprising presenting content at a specific point of the content navigation session based on interaction with a corresponding node in the view.

17. The computer-readable storage medium of claim 15, further comprising returning to a point of the content navigation session via interaction with a node or branch of the view.

18. The computer-readable storage medium of claim 15, further comprising presenting a list of content topics that relate to one or more content navigation sessions and corresponding history data based on selection of a specific content topic.

19. The computer-readable storage medium of claim 15, further comprising graphically differentiating the nodes of the graphical view by domain.

20. The computer-readable storage medium of claim 15, further comprising navigating to a web document based on selection of content associated with a node.
